(19) United States
(12) Patent Application Publication
(10) Pub. No.: US 2019/0389183 A1
(43) Pub. Date: Dec. 26, 2019

(54) SINGLE-SIDED PAPER VENEERED PLYWOOD AND METHOD OF MANUFACTURE

(71) Applicant: Dalian Rapider Wood Products Co., Ltd., Dalian (CN)

(72) Inventors: Chenguang Liu, Dalian (CN); Mintian Liu, Dalian (CN)

(73) Assignee: Dalian Rapider Wood Products Co., Ltd., Dalian (CN)

(21) Appl. No.: 16/441,003

(22) Filed: Jun. 14, 2019

(30) Foreign Application Priority Data
Jun. 22, 2018 (CN) 201810650827.5
Jun. 22, 2018 (CN) 201810651798.4
Jun. 22, 2018 (CN) 201810652849.5

(51) Int. Cl. B32B 21/06; B32B 37/12; B27D 1/08; B27D 5/00

(52) U.S. Cl. CPC B32B 21/06; B32B 37/12; B32B 2250/42; B27D 5/00; B27D 1/08

(57) ABSTRACT

A plywood panel includes multiple softwood layers and multiple hardwood layers that alternatively-tacked and bonded each other using adhesive. The face and the back of the plywood panel are both softwood layers. The number of the multiple softwood layers is one more than the number of the multiple hardwood layers. A single a paper veneer glued to the top-most softwood layer. A single layer of paper veneer is attached to the top-most softwood layer.

### CROSS-REFERENCE TO RELATED APPLICATIONS

This application claims the benefit of Chinese Patent Application No. 201810650827.5, filed Jun. 22, 2018, Chinese Patent Application No. 201810651798.4, filed Jun. 22, 2018, and Chinese Patent Application No. 201810652849.5. The entire disclosures of the applications referenced above are incorporated by reference.

### FIELD

The present disclosure relates to single-sided paper veneered plywood and method of manufacture the same and more particularly to single-sided paper veneered plywood panels having several alternative layers of softwood and hardwood to prevent deformation.

### BACKGROUND

Traditional plywood panels are manufactured by joining multiple layers of thin wood panels of the same kind. Because of the single kind of panel material, the moisture content of every thin layer stays the same and tends to bend in the same way. Thus, paper veneering on one side of the plywood does not prevent bending over time. In order to prevent the bending, manufacturers have to veneer both sides of the plywood panel with paper, thereby increases the material and manufacturing costs of the plywood. Therefore, there is a need for plywood structures to achieve better deformation resistance.

The background description provided here is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### BRIEF DESCRIPTION OF THE DRAWINGS

The present disclosure will become more fully understood from the detailed description and the accompanying drawings.

FIG. 1 is a cross-sectional view of a plywood panel according to the principles of the present disclosure.

FIG. 2 is a perspective view of a single-sided paper veneered plywood panel according to the principles of the present disclosure.

FIG. 3 is an exploded view of the single-sided paper veneered plywood panel of FIG. 2.

FIG. 4 is flowchart showing an example process of manufacturing the veneered paper panel of the single-sided veneered plywood panel according to the principles of the present disclosure.

In the drawings, reference numbers may be reused to identify similar and/or identical elements.

### DETAILED DESCRIPTION

### Introduction

The present disclosure identifies a solution to reduce the material and manufacture costs of traditional plywood manufacturing process. Specifically, the present disclosure offers a single-side paper-veneered plywood panel that prevents bending over time.

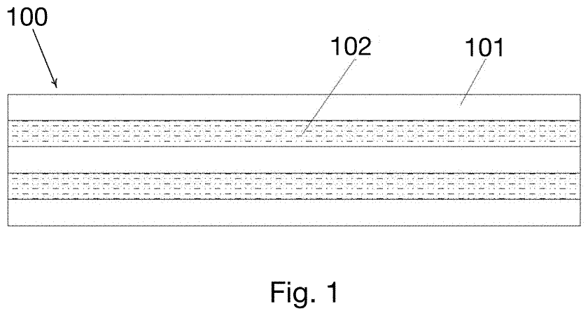

FIG. 1 illustrates a cross-sectional view of a plywood panel 100 with a structure that can resist deformation. The plywood panel 100 may include multiple alternative layers of softwood 101 and hardwood 102. Plywood panels surfaces are usually sanded smooth in manufacture to meet requirements of their intended applications or to make the panel thickness more uniform. The example applications of the panels may be, for example, cabinets, shelving, furniture, built-ins, etc.

Because it is relatively easier to sand softwood layers than hardwood layers, the surface layers are preferably both softwood layers, as shown in FIG. 1. Thus, the number of softwood layers is greater than the number of hardwood layers by one.

The softwood layers have different moisture content and bending characteristics than hardwood layers. As such, when each of the hardwood layers and the softwood layers are stacked and bonded to each other, the different bending effects can compensate each other to thereby reduce the bending of the plywood over time.

The softwood layers can be made of, for examples, pine, poplar, or aspen. The hardwood layers can be made of, for examples, birch or eucalyptus.

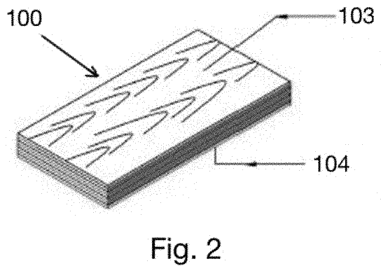

Having such a deformation-resist structure, the plywood panel 100 may only need to include one layer of paper veneer 103 attached to one side of the plywood panel 100, as shown in FIG. 2. Additionally, the other side of the plywood panel 100 can be applied a UV coating 104, which adds toughness, waterproof and scrapes and deformation resistance. UV coatings are cheaper than paper veneers. As such, the present disclosure provides a more cost-effective plywood solution.

Since both outer sides of the plywood panel 100 are softwood layers, the paper veneer 103 and the UV coating 104 are both attached onto the softwood layers respectively.

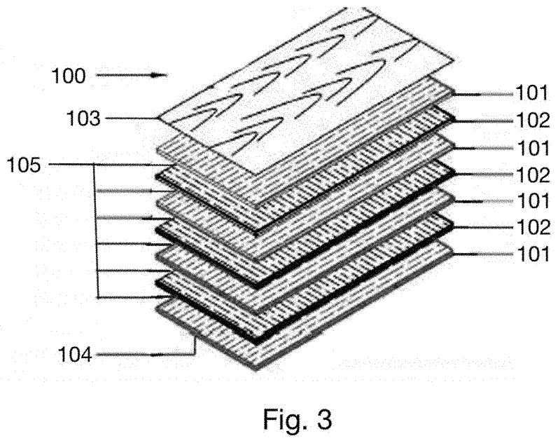

FIG. 3 is an exploded view of the single-sided paper veneered plywood panel 100. As shown in FIG. 3, the layers or plies of hardwood 102 and softwood 101 are glued together with an adhesive 105. Further, the adjacent layers are glued with their wood grains run 90 degrees to one another. In other words, the angle between the grains of adjacent layers (i.e., hardwood and softwood layers) is generally 90°. As such, the deformation resistance of plywood panel 100 is further improved.

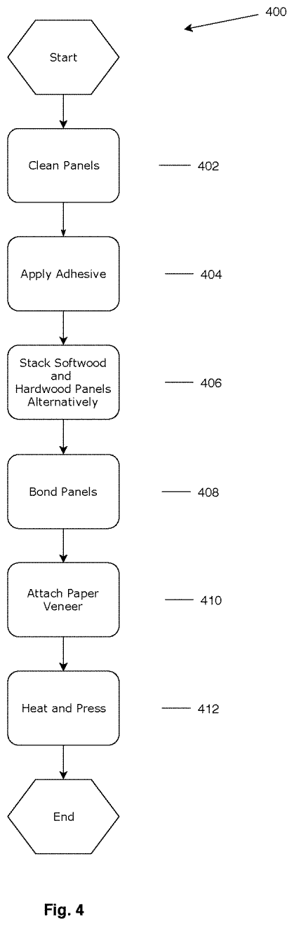

FIG. 4 shows a manufacture process 400 of the single-side paper-veneered plywood panel 100 with multiple steps: at 402, clean the contacting surfaces of multiple hard wood layers and multiple soft wood layers; at 404, apply adhesive (e.g., glue, etc.) to the cleaned contacting surfaces; at 406, alternatively stack the multiple softwood layers and the multiple hardwood layers so that each of the multiple hardwood layers is adjacent to one of the multiple softwood layers on both sides, and both the top and the bottom layers are softwood layers; at 408, bond the multiple softwood layers and the multiple hardwood players with the applied adhesive on the contacting surfaces; at 410, attach a paper veneer onto the face of the plywood (i.e., the top surface of the softwood layer that is stacked on the top side of the plywood panel) with the applied adhesive; and at 412, heat and press the bonded multiple softwood and hardwood layers to form the plywood panel. Additionally, a UV coating may be applied to the bottom surface of the the softwood layer that is stacked on the bottom side of the plywood panel.

Particularly in step 402, the cleaning procedures may include roller brushing, air blowing, and vacuuming. Additionally, in step 404, the adhesive may be applied by a pneumatic glue applier (e.g., automatic roller lines). The amount of adhesive applied can be set to about 45 grams per square meter. Further in step 412, the glued plywood can be placed into a hot compressing machine. Each plywood panel is generally pressed at a pressure of about 10 Megapascal (MPa) and heated to a temperature of about 90-110° C. with the pressure maintained for about 3-5 seconds to finish the manufacture process.

The manufacture process of adhering two different materials adjacent to each other providing a better plywood structure to achieve stronger deformation resistance. Since the moisture content of each layer is different, different layers are capable of holding each other to the original flat state without bending or curling. As such, having only one side veneered with paper is feasible.

### CONCLUSION

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules) are described using various terms, including “connected,” “engaged,” “interfaced,” and “coupled.” Unless explicitly described as being “direct,” when a relationship between first and second elements is described in the above disclosure, that relationship encompasses a direct relationship where no other intervening elements are present between the first and second elements, and also an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A. The term subset does not necessarily require a proper subset. In other words, a first subset of a first set may be coextensive with (equal to) the first set.

What is claimed is:

1. A plywood panel comprising:
a plurality of softwood layers; and
a plurality of hardwood layers,
wherein:
the plurality of softwood layers and the plurality of hardwood layers are alternatively-stacked and bonded with each other using adhesive,
the plurality of softwood layers having a top-most softwood layer bonded on the face of the plywood panel and a bottom-most softwood layer bonded at the back of the plywood panel, and
the number of the plurality of softwood layers is one more than the number of the plurality of hardwood layers.

2. The plywood panel of claim 1, further comprising a paper veneer attached to the top-most softwood layer.

3. The plywood panel of claim 2, further comprising a UV coating attached to the bottom-most softwood layer.

4. The plywood panel of claim 1, wherein the plurality of softwood layers is made of pine, poplar, or aspen.

5. The plywood panel of claim 1, wherein the plurality of hardwood layers is made of birch or eucalyptus.

6. The plywood panel of claim 1, whereas each layers grain runs at a right angle to a grain of the adjacent layer.

7. A method of manufacturing a plywood panel, comprising steps of:
respectively cleaning contacting surfaces of a plurality of hardwood layers and contacting surfaces of a plurality of softwood layers;
applying adhesive to the contacting surfaces of the plurality of hardwood layers and the contacting surfaces of the plurality of softwood layers;
alternatively stacking each of the plurality of softwood layers and each of the plurality of hardwood layers so that each of the plurality of the hardwood layers is adjacent to a softwood layer of the plurality of the softwood layers on both sides, with one of the plurality of softwood layers being stacked on the top side and another one of the plurality of softwood layers being stacked on the bottom side;
bonding the plurality of softwood layers and the plurality of hardwood layers with the applied adhesive on the contacting surfaces; and
heating and pressing the bonded plurality of softwood layers and the plurality of hardwood layers to form the plywood panel.

8. The method of claim 7, further comprising: attaching a paper veneer onto the top surface of the softwood layer that is stacked on the top side of the plywood panel.

9. The method of claim 8, further comprising: applying a UV Coating to the bottom surface of the softwood layer that is positioned on the bottom side of the plywood panel.

10. The method of claim 7, wherein the step the cleaning comprises: roller brushing, air blow cleaning, and vacuuming.

11. The method of claim 7, wherein the step of applying the adhesive comprises: applying the adhesive by using automatic pneumatic glue applier.

12. The method of claim 11, wherein the amount of glue applied is set to 45 grams/square meter.

13. The method of claim 7, wherein the step of pressing comprises pressing using a hot-pressing machine.

14. The method of claim 13, wherein whereas a pressure is set at about 10 MPa for about 3-5 seconds and a temperature is set at about 90-110° C.
